(19) United States
(12) Patent Application Publication
(10) Pub. No.: US 2021/0255100 A1
(43) Pub. Date: Aug. 19, 2021

(54) PARTICULATE MATTER SENSOR MODULE USING COMPOUND PARABOLIC/ELLIPTICAL COLLECTOR

(71) Applicants: Agency for Science, Technology and Research, Singapore (SG); National University of Singapore, Singapore (SG)

(72) Inventors: Jifang Tao, Singapore (SG); Chia-Hung Chen, Singapore (SG); Yingying Qiao, Singapore (SG); Weikang Nicholas Lin, Singapore (SG); Alex Yuandong Gu, Singapore (SG)

(21) Appl. No.: 16/967,641

(22) PCT Filed: Feb. 8, 2019
(86) PCT No.: PCT/SG2019/050071

§ 371 Date: Aug. 5, 2020

(30) Foreign Application Priority Data
Feb. 8, 2018 (SG) 10201801092S

(51) Int. Cl. G01N 21/53; G01N 15/02; G01N 15/06

(52) U.S. Cl. CPC G01N 21/53; G01N 15/06; G01N 15/0211

(57) ABSTRACT

A sensor module for detecting particulate matter of an aerosol, which may include a source of electromagnetic radiation and a collector for electromagnetic radiation. The collector may include a cavity and a first opening for the aerosol. The cavity may be reflective for the electromagnetic radiation. The first opening may allow exchange of the aerosol in and out of the cavity. The source of electromagnetic radiation may be arranged to project the electromagnetic radiation onto the aerosol which may be scattered as scattered electromagnetic radiation. The sensor module may include a detector of electromagnetic radiation arranged to detect the scattered electromagnetic radiation that is reflected by the collector. The source and the detector may be arranged on a same side of the collector. The source and the detector may be arranged at a same aperture of the collector.

### CROSS-REFERENCE TO RELATED APPLICATION

This application claims the benefit of priority of Singapore patent application No. 10201801092S filed on Feb. 8, 2018, the contents of it being hereby incorporated by reference in its entirety for all purposes.

### TECHNICAL FIELD

Various aspects of this disclosure relate to a sensor module for detecting particulate matter of an aerosol and to electronic devices including such sensor module.

### BACKGROUND

Detection and measurement of particulate matter (PM) concentrations using is very important for health-related purposes. Inhalation of PM2.5 (PM with aerodynamic 2.5 μm and below) and PM10 (PM with aerodynamic 10 μm and below) have been linked with a slew of health problems.

Currently, most commercial PM sensor modules use the principle of light scattering as the sensing method for detecting PM. Typically, these PM sensor modules are low-cost and are easy to operate. However, their sizes which typically range from 5-10 cm (width/length) by 2 cm (height), make them difficult to be integrated into consumer electronic devices such as hand phones. Additionally, these PM sensor modules typically use a single LED-photodiode sensor-detector pair for their PM detection system, which assesses only a small range of angles of light scattered from the PM. This may result in a lower limit of detection of the sensing platform since scattered light signal intensity is very low at low PM concentrations.

Scattering signal derived by PM can be greatly enhanced through the use of optical elements. However, these optical elements are usually not included in other commercial PM sensor modules presumably because of the difficulties of integrating them into the existing sensor module designs without increasing the module size.

### SUMMARY

Various embodiments may provide a sensor module for detecting particulate matter of an aerosol. The sensor module may include a collector for electromagnetic radiation. The collector may include a cavity and a first opening for the aerosol. The cavity may be reflective for the electromagnetic radiation. The first opening may allow exchange of the aerosol in and out of the cavity. The sensor module may include a source of electromagnetic radiation. The source of electromagnetic radiation may be arranged to project the electromagnetic radiation onto the aerosol. The source of electromagnetic radiation may be arranged to project the electromagnetic radiation onto the aerosol so that at least a part of the electromagnetic radiation may be scattered by the particulate matter in the cavity so as to become scattered electromagnetic radiation. The sensor module may include a detector of electromagnetic radiation arranged to detect the scattered electromagnetic radiation that is reflected by the collector. The source and the detector may be arranged on a same side of the collector. The source and the detector may be arranged at a same aperture of the collector.

Various embodiments may provide a use of the sensor module as a sensor module integrated in an electronic device or as a sensor module connectable to an electronic device.

Various embodiments may provide an electronic device comprising the sensor module.

### BRIEF DESCRIPTION OF THE DRAWINGS

The invention will be better understood with reference to the detailed description when considered in conjunction with the non-limiting examples and the accompanying drawings, in which:

FIG. 1 shows a schematic cross sectional view of a sensor module 100, in accordance with various embodiments.

FIG. 2 shows the schematic cross section of the sensor module 100 of FIG. 1 and how electromagnetic radiation is scattered by an exemplary dust particle.

FIG. 3 shows an exemplary outer view of a sensor module 100 comprising a body cap and a collector body, in accordance with various embodiments.

FIG. 4 shows a schematic cross sectional view of a sensor module 100 comprising a body cap and a collector body, in accordance with various embodiments.

FIG. 5 shows is identical to FIG. 4 wherein it is further represented how light is scattered by an exemplary dust particle.

FIG. 6 shows a comparative sensor module 600, comprising an LED and a photodetector.

FIG. 7A and FIG. 7B shows how light scatters on a dust particle and is detected by the detector when the collector is not present (FIG. 7A) and with the collector according to various embodiments (FIG. 7B).

FIG. 8 shows a plot 800 of the scattering light power percentage as a function of the particle density.

FIG. 9 shows a plot 900 of the optical power received by the photodiode as function of particle mass concentration (PM2.5).

FIG. 10 shows a plot 10000 of a ratio of optical power received by the photodiode as function of particle mass concentration (PM2.5).

### DETAILED DESCRIPTION

The present disclosure concerns a sensor module which has integrated optics, preferably in the form of a collector, for example in the form of a compound parabolic collector (CPC) or compound elliptical collector (CEC).

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may also be used herein to mean that the deposited material may be formed “indirectly on” the implied side or surface with one or more additional layers being arranged between the implied side or surface and the deposited material. In other words, a first layer “over” a second layer may refer to the first layer directly on the second layer, or that the first layer and the second layer are separated by one or more intervening layers.

The device arrangement as described herein may be operable in various orientations, and thus it should be understood that the terms “top”, “bottom”, etc., when used in the following description are used for convenience and to aid understanding of relative positions or directions, and not intended to limit the orientation of the device arrangement.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

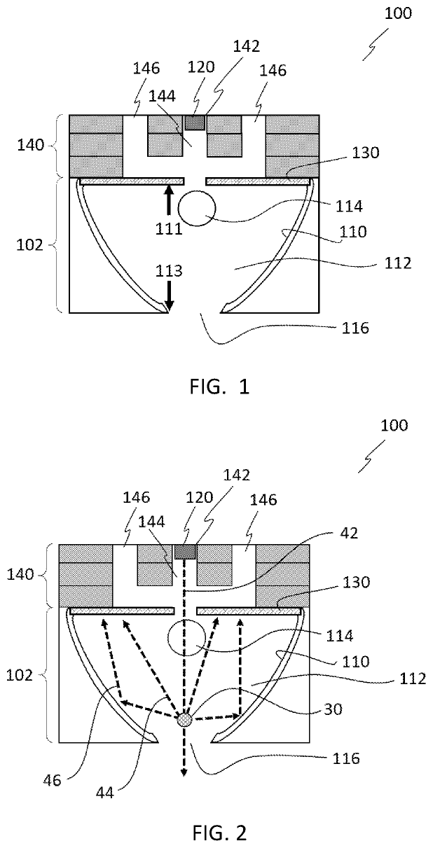

Various embodiments may provide a sensor module for detecting particulate matter of an aerosol. FIG. 1 shows a schematic cross sectional view of a sensor module 100, in accordance with various embodiments. The sensor module 100 of FIG. 1 is shown as an exemplary, non-limiting, embodiment. The sensor module 100 may include a collector 110 for electromagnetic radiation.

A collector according to various embodiments of the invention may be a compound collector. Within the context of the present disclosure, the collector may be a compound parabolic collector (CPC), this may mean that the cavity of the collector has the shape of a compound parabolic collector, and the inner surface is reflective. The collector may be a compound elliptical collector (CEC), this may mean that the cavity of the collector has the shape of a compound elliptical collector, and the inner surface is reflective. For example, the inner surface of the collector may comprise a reflective material, for example be coated with a reflective material. The inner surface of the collector may be reflective in the wavelength ranges for visible light, IR, NIR, UV, or an overlap or combination thereof. Within the context of the present disclosure, the term “CPC/CEC” means a CPC or a CEC.

The inner surface of the cavity may comprise an aluminum-magnesium alloy. For example, the collector may comprise or be made of an aluminum-magnesium allow. The aluminum-magnesium alloy provide a collector with improved reflectivity, for example, for visible light, for example at the 600 nm to 700 nm wavelength range, for example at 650 nm. Aluminum-magnesium alloy also has the advantage that the optical components, such as the collector, may be produced with high precision optical fabrication. In one example, the inner surface of the cavity (e.g. of a CPC/CEC collector) may comprise an aluminum-magnesium with maximum reflectance in the visible in the 600 nm to 700 nm wavelength range, and the source may be a visible LED with emission peak in the 600 nm to 700 nm wavelength range, for example, at 650 nm.

Within the context of the invention, a reflective surface may mean that the surface has a substantially high reflection at the wavelengths of the electromagnetic radiation, preferably at a common wavelength of the electromagnetic radiation and the detector. Substantially high reflection may mean a reflectance greater than 40%, preferably greater than 80%, further preferably greater than 90%, for example, at the wavelength range, for example at an emission peak wavelength of the source.

Within the context of the invention, and in accordance with various embodiments the cavity may define a sensing chamber or the cavity and the body cap may define the sensing chamber. Within the present disclosure, some explanations may be referred only to the cavity, however, it will become evident that these explanations may apply in the same manner to the sensing chamber.

The sensor module may include a first opening which may be a single opening for exchange of the aerosol within the cavity (and the sensing chamber), meaning, in and out of the sensor module. Alternatively the sensor module may include a plurality of openings (e.g. two or more), the plurality of openings including the first opening, for exchange of the aerosol within the cavity (and the sensing chamber), or alternatively or in addition, the plurality of openings may include at least an opening as an inlet and at least another opening as an outlet, the inlet and the outlet serving as a passage through which the aerosol may flow through the cavity (and the sensing chamber). The term “aerosol” according to the present disclosure may mean a gas including particular matter, for example a colloid of fine solid particles in air.

The opening(s) may be included in the collector, for example in the reflective cavity. Within the context of the present disclosure, the term “opening” may refer to the holes or through-bores, such as inlet and/or outlets, which are associated with the transport (or flow) of the aerosol from the outside of the sensor module to the inside of the cavity (and the sensing chamber) and from the inside of the cavity (and the sensing chamber) to the outside of the sensor module.

As shown, for example in FIGS. 1 and 2, the collector 110 may include a cavity 112 and a first opening 114 for the aerosol. The first opening may be included in the reflective cavity. The first opening may be part of a plurality of openings.

The cavity may be reflective for the electromagnetic radiation. The collector includes at least one main aperture (also named main entrance aperture or entrance aperture), which may be the largest aperture of the collector in case that more than one aperture is provided. The reflective cavity may further include an exit aperture for the part of the electromagnetic radiation (e.g., light beam) that was not scattered. Within the context of the present disclosure, the term “aperture” may refer to the holes or through-bores, such as main and secondary apertures, which are associated to the beam path or the electromagnetic radiation. For example, the main aperture of a collector may be an entrance aperture, e.g. a larger aperture. For example, the secondary aperture of a collector may be an exit aperture. The main aperture and the secondary aperture may be disposed on opposed sides of the collector, for example, such that a non-scattered light beam may at least partially be transmitted, as a straight beam, through the apertures and through the cavity of the collector. Thus, the inlet and the outlet may be axially aligned to each other. The source may be arranged accordingly to generate a beam that, when not scattered, transmits at least partially, for example substantially completely, as a straight beam, through the apertures and through the cavity of the collector. The main aperture and the secondary aperture may be axially aligned to the axis of the cavity in the case the cavity is a surface of revolution.

In some embodiments, at least one aperture may coincide with one opening, for example, the exit aperture, which enables exit of the non-scattered portion of the electromagnetic radiation (emitted by the source) to the outside of the cavity, may also be configured to allow transport of aerosol in and out of the sensor module.

The reflective cavity of the collector may be, for example, a surface of revolution including an axis of revolution. As mentioned above, the reflective cavity may further include features, e.g. a first opening or a plurality of openings including the first opening. If the cavity is a surface of revolution, then the openings would be off axis and not features of revolution. For example a CPC may have a reflective cavity, wherein the reflective cavity is a body of revolution, and the reflective cavity may further include openings such as inlets and/or outlets for aerosol. The reflective cavity may include an exit aperture for the part of the electromagnetic radiation (e.g., light beam) that was not scattered. The collector may include a second opening, allowing for flow of aerosol between the first opening and the second opening and through the cavity. The first opening, or the second opening (if available), may coincide with the secondary aperture, for example, the exit aperture. While some embodiments are explained with the cavity of the collector being a surface of revolution, the invention is however not limited thereto. For example, in some embodiments, instead of a surface of revolution, only parts or sections of the cavity may be embodied as a surface of revolution.

Within the context of the invention, an axial arrangement may mean that the components are aligned along a common axis, for example a common optical axis and/or a common axis of symmetry and/or a common axis of revolution. For example, the source and the detector have an axial arrangement may mean that the detector is positioned, preferably centered, within a line called axis, and the source is positioned, preferably centered, within the same axis, the source and the detector are said to form an axial arrangement. The axis may be, for example, an axis of center, an axis of a body of revolution, an axis of symmetry. In some embodiments, the axis of revolution and the optical axis may be a common axis.

According to various embodiments, the source and the detector may have an axial arrangement. Further, the source, the detector, and the secondary aperture may have an axial arrangement.

Within the context of the present disclosure, scattering of electromagnetic radiation by particulate matter may refer to the change of the direction of light propagation due to interaction with the particulate matter. The expression “scattered electromagnetic radiation”, or “scattered light” may mean electromagnetic radiation from the source scattered by particulate matter which may be in the aerosol in the cavity.

Turning to FIGS. 1 and 2, by way of example, it is shown that the sensor module may include a source 120 of electromagnetic radiation. The source 120 and the detector 130 may be arranged on a same side 111 of the collector 110. The source 120 and the detector 130 may be arranged at a same aperture of the collector 110. The same aperture of the collector may be primary aperture of the cavity, for example a main entrance aperture.

The source 120 may be a light emitting diode (LED), for example a visible LED, or an IR LED. The source 120 may be disposed so that electromagnetic radiation emitted from the source is emitted towards the cavity 112, so that aerosol particles in the cavity may scatter the electromagnetic radiation. For example, the source 120 may be positioned on a first side 111 of the collector 110 in such a way that electromagnetic radiation (e.g. light) is emitted towards the inside of the collector 110, into the cavity 112. The first side 111 may be main aperture of the collector 110.

The electromagnetic radiation emitted by the source may be collimated, for example in the form of a collimated beam. Within the context of the present disclosure, the term “collimated” may mean that the sensor module is configured to have a beam divergence emitted from the direction of the source smaller than 180 degrees, preferably smaller than 45 degrees, further preferably smaller than 30 degrees, for example equal or smaller than 10 degrees. The structural features leading to the collimation could be integrated in the source (e.g. the lens of an LED) and/or could be additionally included in the sensor module, for example as a lens, a collimation orifice, or a combination thereof.

The source 120 may be included in a body cap 140. The body cap may be configured to be coupled to a collector body 102, which collector body 102 may include the collector 110.

The source 120 may be supported in an orifice 142 in a body cap 140. For example, the orifice 142 may be configured, e.g. sized, to receive the source 120, e.g. an LED. The source 120 may emit electromagnetic radiation towards the cavity 112. The optical axis 42 of such emission is represented in FIGS. 1 and 2 by way of example.

Within the context of the present disclosure, the detector may include a photodiode. The detector may also include a plurality of photodiodes.

The detector 130 may be disposed on the first side 111 of the collector. The first side 111 may be the main aperture of the collector 110. The detector may be disposed in such a way that substantial part of electromagnetic radiation, e.g. light, scattered by particular matter and reflected by the reflector is incident on the detector. The detector may cover a substantial area, for example more than half of the area, of the main aperture of the collector.

The detector may be arranged such that the source is on one side of the detector and at least a main portion of the cavity is on another side of the detector. For example, as shown in FIGS. 1 and 2, electromagnetic radiation is emitted from a source 120 from one side of the detector 130 towards the cavity 112 which is on another side of the detector 130. To avoid impeding the transmission of electromagnetic energy, e.g. light, the detector 130 may be disposed such that it leaves at least a portion of the main aperture open, which is sufficiently large for transmission of electromagnetic energy. Thus, the detector 130 may be configured to not completely cover the main aperture of the collector 110. The detector may be arranged around the collimated beam.

The detector 130 may include or have a shape of an annulus. Within the context of the invention, an annulus may mean a region bounded by two concentric circles. For example, an annular detector may have the shape of a flat hardware washer (also named as “Donut” or “Donut shaped” in the present disclosure). Such an annular detector may comprise, e.g., an annular photodiode or an annular arrangement of photodiodes. An annular detector may comprise other features, for example pins for electrical connections. In one example, the annular detector 130 may be disposed in the sensor module such that its central opening allows electromagnetic radiation emitted by the source 120 to reach the cavity 112.

FIG. 2 shows the schematic cross section of the sensor module 100 of FIG. 1 and how electromagnetic radiation is scattered by an exemplary dust particle. The source 120 of electromagnetic radiation may be arranged to project the electromagnetic radiation into the cavity 112, thus onto the aerosol when it is present. At least a part of the electromagnetic radiation may be scattered by the particulate matter 30 (included in the aerosol) in the cavity 112 so as to become scattered electromagnetic radiation. The sensor module 100 may include a detector 130 of electromagnetic radiation arranged to detect the scattered electromagnetic radiation 46 that is reflected by the collector 110. The detector may also detect scattered electromagnetic radiation which is scattered 44 at such an angle that it is not reflected by the collector 110.

The electromagnetic radiation may be visible light, IR, NIR, UV, or an overlap or combination thereof. Within the context of the present disclosure, the term “light” may be used to explain the invention referring to visible light by way of example, however the invention is not limited thereto. Instead of visible light, other kinds of electromagnetic radiation can be used for example, infrared (IR) light, near-infrared (NIR) light, ultraviolet (UV) light, etc.

Within the context of the present disclosure, IR may mean electromagnetic radiation with a wavelength from 700 nm to 1 millimeter. The endpoints of the range are included in the range.

Within the context of the present disclosure, NIR may mean electromagnetic radiation with a wavelength from 700 nm to 1500 nm. The endpoints of the range are included in the range.

Within the context of the present disclosure, UV light may mean electromagnetic radiation with a wavelength from 10 nm to 400 nm. The endpoints of the range are included in the range.

Within the context of the present disclosure, visible light may mean electromagnetic radiation with a wavelength from 400 nm to 700 nm, for example with a wavelength range of 600 nm to 700 nm. The endpoints of the range are included in the range.

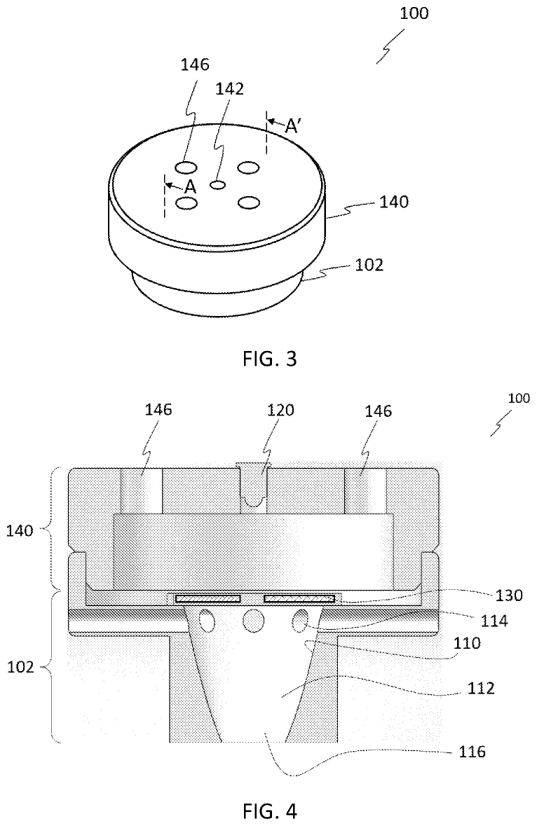

FIG. 3 shows an exemplary outer perspective view of a sensor module 100 comprising a body cap 140 and a collector body 102, in accordance with various embodiments. The body cap may be adapted to close the cavity, for example to close the primary aperture of the collector. The cap may house electronic components, for example at least one of: the source, the detector, a printed circuit board (PCB). The PCB may support at least one of: the source, the detector, a driving circuit, a processing circuit. The body cap 140 may include an orifice 142 in which the source may be disposed. For example, orifice 142 may be for the placement of an LED. Alternatively or in addition, the orifice may be a collimating hole. The body cap 140 may include further orifices 146, for example to provide fixation means (e.g. screws or plugs). Within the context of the present disclosure, the term “orifice” may refer to the holes or through-bores, which are associated with the mechanical connection of elements, for example the LED orifice. The body cap 140 may be larger than the collector body 102, however the disclosure is not limited thereto.

According to various embodiments, the collector body and the body cap may be provided separately. The collector body, for coupling to the body cap, may include the collector for electromagnetic radiation. The collector may include the cavity, wherein the cavity is reflective for the electromagnetic radiation, and the first opening for the aerosol, for allowing exchange of the aerosol in and out of the cavity. The collector body may include a first part of a coupling for coupling with the second part of a coupling comprised by the body cap.

The body cap, for coupling to the collector body, may include the source of electromagnetic radiation arranged to project the electromagnetic radiation onto the aerosol, wherein at least a part of the electromagnetic radiation may be scattered by the particulate matter in the cavity so as to become scattered electromagnetic radiation. The body cap may further include a second part of a coupling for coupling with the first part of the coupling comprised by the collector body. The body cap may optionally further include the detector of electromagnetic radiation arranged to detect the scattered electromagnetic radiation that is reflected by the collector. However, the invention is not limited thereto, the detector may, for example, be included in the collector body or be disposed as separate part between the collector body and the body cap. In a coupled state, the source and the detector may be arranged on a same side, preferably at a same aperture, of the collector.

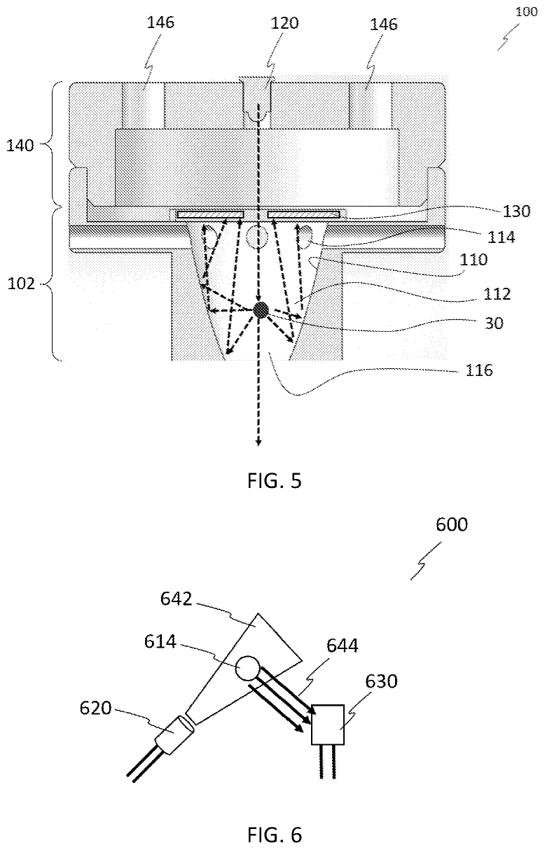

FIGS. 4 and 5 show a schematic cross sectional view of the cross section A-A′ of the sensor module 100 of FIG. 3. In FIG. 5, it is shown how light is scattered by an exemplary dust particle.

FIGS. 4 and 5 show a sensor module 100 including a body cap 140 and a collector body 102 coupled together. The body cap 140 may include an orifice for the source 120 and may include further orifices 146. The further orifices may be for example, for placement of additional photodiodes, placement of a PCB. When the source 120 is disposed on the body cap 140 and the body cap 140 is coupled to the collector body 102, electromagnetic energy emitted by the source is emitted into reflective the cavity 112, for example in the form of a beam. The cavity 112 is part of the collector 110 which may include an exit aperture 113 opposite to the main aperture 111. The exit aperture 113 may be disposed on a same line with the beam of electromagnetic energy. In other words, the source may be disposed such that at least a portion of its emitted electromagnetic energy is emitted through the exit aperture 113 and is thus not reflected by the cavity 112.

The detector 130 may be disposed on the main aperture of the collector 110 so that most of the scattered and/or scattered-and-reflected electromagnetic energy may be incident on, and be detected by, the detector. The detector 130 may be disposed between the reflective cavity 112 and the source 120 such that the beam of electromagnetic energy emitted by the source is, at least mostly, for example totally, unblocked by the detector 130. A circular photodiode with a hole in the center (hence a donut shape) may be arranged on the top of the collector 110.

FIGS. 4 and 5 show that openings may be provided for the aerosol, for example opening 114. Exit aperture 116 may also function as opening for exchange of aerosol between outside and inside of the cavity 112. The collector body 102 may include multiple openings to allow the entry of atmospheric aerosol in the chamber. The chamber may be defined when the collector body 102 is coupled to the body cap 140. Within the context of the invention, the sensing chamber may be defined by the cavity, and when closed by the cap, may be the volume comprised within the cavity walls and the cap.

A shown in FIG. 6, an exit orifice is situated at the base of the particulate matter sensor module to unscattered light to leave the sensor module, in order to prevent signal interference with scattered signal. When light emitted from the light source is scattered by the PM, the resulting scattering occurs in all directions. Some of this light directly reaches the photodiode, while some of this light gets reflected by the collector back to the detector (in the detector's direction), for example, a photodiode. When electromagnetic energy from the source is scattered by particular matter 30 comprised in the aerosol, then scattered light may be received by the detector 130 or reflected by the collector 110 and thereby directed to the detector 130. The detector may generate an electrical signal corresponding to the light intensity received by the detector. This electrical signal can then be used to correlate to PM mass concentration data.

According to various embodiments, scattered light larger than a predetermined angle are reflected, by the collector in the detector's direction. The angle maybe, for example, 10 degrees. Thus, only light scattered from the particles at angles more than 10 degrees would be collected by the photodiode.

FIG. 6 shows a comparative sensor module 600, comprising an LED and a photodetector. In the comparative sensor module 600, a light source 620 is used to emit a light beam 642 and a detector 630 is placed so that its detection window partially overlaps with the light beam 642. When light from the light beam 642 scatters on particles 614, some of this light (644) may be in the detection window of the detector 630 and may thus be detected by detector 630. As can be seen, since only light 644 scattered by the correct angle may be detected, such a conventional arrangement has a lower sensitivity as compared to the sensor module of the present disclosure.

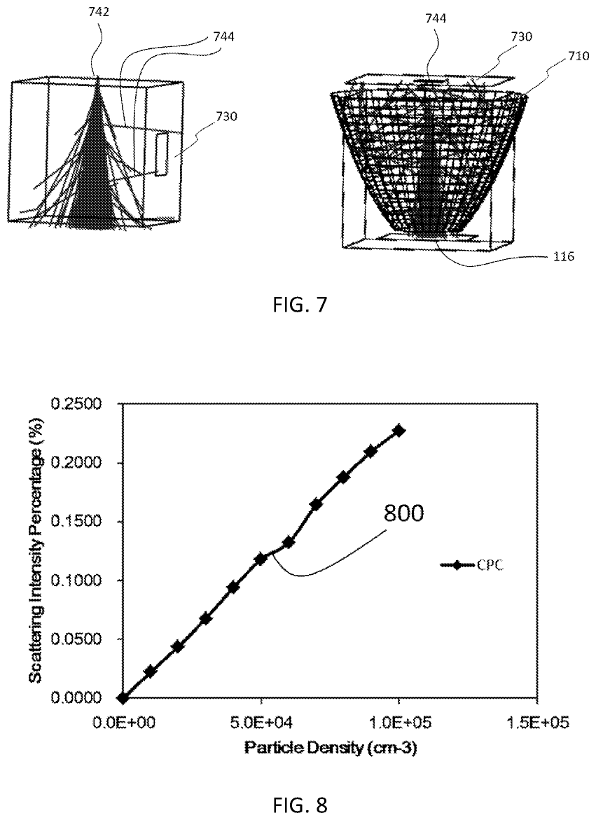

FIG. 7A and FIG. 7B shows how light scatters on a dust particle and is detected by the detector when the collector is not present (FIG. 7A) and with the collector according to various embodiments (FIG. 7B).

FIG. 7A represents a simulation domain having an aerosol with particular matter. A source (not shown) is placed on the top, and light (represented by rays originating from the top) is emitted by the source as a light beam 742. On the right side is a detector 730. While many of the light rays of the light beam 742 are scattered by particular matter, only a very few are incident on the detector 730.

FIG. 7B represents a simulation domain similar to the one of FIG. 7A, having an aerosol with particular matter with a same concentration as in FIG. 7A. However, in FIG. 7B, a collector 710 is included, and the detector 730 is disposed on the main aperture of the collector. Due to the presence of the collector 710, many of the light rays scattered by particular matter are reflected to the main aperture and thus reach the detector 730. As can be seen, the detector of FIG. 7B receives more scattered light rays than the detector of FIG. 7A, while the emitted, and not scattered, rays exit the collector on the exit aperture.

FIG. 8 shows a plot 800 of the scattering light percentage as a function of the particle density. The scattering intensity percentage is the percentage of scattered light power detected compared to total light power from the LED.

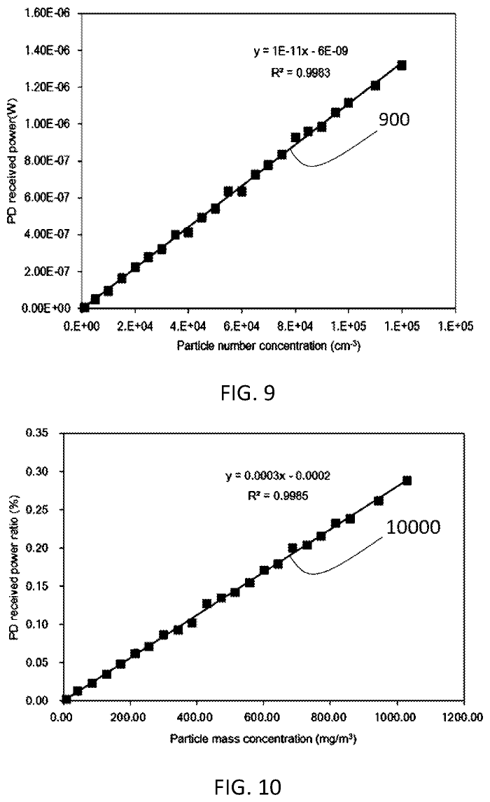

FIG. 9 shows a plot 900 of the optical power received by the photodiode as function of particle mass concentration (PM2.5).

FIG. 10 shows a plot 10000 of a ratio of optical power received by the photodiode as function of particle mass concentration (PM2.5).

Numerical simulations were performed to determine the theoretical performance of the sensor module according to various embodiments. In the numerical simulations, the source used is a monochromatic LED with wavelength at 650 nm (MTE4064PT-UR, Marktech Optoelectronics) with a power output set at 1 mW. As detector, a photodiode (FDS1010, THORLABS, INC) was used, which can convert incident light into electrical current. The parameters of the photodiode are Noise Equivalent Power (NEPₘₐₓ)=2.07×10⁻¹³ W/\sqrt{Hz}, Maximum dark current: 600 nA, Responsivity @650 nm (R_{650 nm}): ≈0.4 A/W, Max Responsivity (Rₘₐₓ): 0.725 A/W. The Noise Equivalent Power (NEP) at different wavelengths (NEP_{λ}) can be calculated by the following formula:

$${NEP}_{λ} = {NEP}_{max} \times \frac{{R}_{λ}}{{R}_{max}}$$

Where R_{λ} responsivity at a certain wavelength, and Rₘₐₓ is the maximum responsivity. Thus, at 650 nm,

$${NEP}_{650 nm} = 2.07 \times 1 {0}^{- 13} \times ( \frac{0.4}{0.725} ) = 1.142 \times 1 {0}^{- 13} W / \sqrt{H z} .$$

On the basis that the ratio of received light power is 1.142×10⁻⁷%, the minimum detectable PM2.5 mass concentration (Cₘᵢₙ) can be derived as:

$${C}_{min} = 1 ( \frac{mg}{{m}^{3}} ) \times \frac{1.142 \times 1 {0}^{- 7}}{3 \times 1 {0}^{- 4}} = 0.38 μ g / {m}^{3}$$

Thus, the minimum expected detectable PM2.5 mass concentration is therefore 0.38 μg/m³.

The present disclosure provides a sensor module wherein a source, a detector and a collector of the sensor module are arranged such that when electromagnetic radiation from the source (e.g., a light beam) is scattered by a particulate matter, for example a particle (e.g. dust), if such particle is present in the cavity, at least part of the scattered electromagnetic radiation may be reflected by the cavity and be detected by the detector. The scattered electromagnetic radiation may also be scattered in a propagation direction towards the detector without requiring being reflected by the cavity. Thus, scattered electromagnetic radiation may be received by the detector from multiple angles and an enhanced signal can be obtained with the sensor module according to various embodiments of the present disclosure.

The sensor module, in accordance with various embodiments, may be provided in a millimeter scale, for example, wherein at least one, or at least two, or all three, orthogonal dimensions have a length of a few millimeters, for example, less than 30 mm. The millimeter scale may facilitate integration into consumer electronics. The sensor module may be produced, for example, using micromachining, for example for the mechanical components.

Due to the integration of components a sensor module according to various embodiments may be provided with a small volume. With the present embodiments, a sensor module may be made possible with a volume of less than 9000 cubic millimeters.

In one example, the device size has a diameter of 27 mm and a height of 15 mm, which is a size that is smaller than other commercial sensor modules and detection products. Also the device weight is lower than 20 g, for example about 17.96 g. Via numerical simulations, it was predicted that the CPC/CEC system can detect mass concentration levels of PM2.5 particles as low as 0.38 μg/m³. This mass concentration value is comparable to other commercial sensor modules, while being more sensitive than some of the commercial detectors.

The present disclosure also provides for the use of the sensor module according to various embodiments as a sensor module integrated in an electronic device.

The present disclosure also provides for the use of the sensor module according to various embodiments as a sensor module connectable to an electronic device.

The present disclosure also concerns an electronic device, including an integrated sensor module or a connected sensor module according various embodiments.

The present disclosure also concerns an electronic device, wherein the device is able to communicate with a sensor module according various embodiments.

The present invention also concerns an electronic device, wherein the device and the sensor module are configured to mechanically fit connect (or simply fit) to each other. Fit connect may mean that both the device and the sensor module have mechanically complementary features, for example two surfaces which can be connected together, a plug (e.g. on the sensor module) and a socket (e.g. on the device).

The electronic device may be a personal electronic device, a consumer electronic device (for example a smartphone), a personal safety equipment, an atmospheric sensor module equipment, or a personal particle monitor.

The electronic device may be used, for example in flour mills, in construction sites, and in hospitals. The sensor may also be used for Indoor Air Quality (IA) measurements.

The sensor module according to various embodiments, maybe used to detect aerosol particles, for example PM1, PM2.5, PM10.

The sensor module according to various embodiments, may also be used in an integrated sensor platform. For example, the sensor module may be combined with other sensor components to form an integrated atmospheric sensor platform. Examples of other sensor components are humidity sensors, volatile organic compound sensors, gas sensors.

Various aspects of the invention may be provided according to following statements which may be combined with various aspects of the previously described embodiments: Statement 1: A sensor module for detecting particulate matter of an aerosol, comprising a collector for electromagnetic radiation, the collector comprising a cavity, wherein the cavity is reflective for the electromagnetic radiation, and a first opening for the aerosol, for allowing exchange of the aerosol in and out of the cavity; a source of electromagnetic radiation arranged to project the electromagnetic radiation onto the aerosol, wherein at least a part of the electromagnetic radiation may be scattered by the particulate matter in the cavity so as to become scattered electromagnetic radiation; a detector of electromagnetic radiation arranged to detect the scattered electromagnetic radiation that is reflected by the collector; wherein the source and the detector are arranged on a same side, preferably at a same aperture, of the collector. Statement 2: The sensor module of statement 1, wherein the collector is a compound elliptical collector. Statement 3: The sensor module of statement 1, wherein the collector is a compound parabolic collector. Statement 4: The sensor module of any of the previous statements, wherein the cavity is a surface of revolution having an axis of revolution. Statement 5: The sensor module of any of the previous statements, wherein the electromagnetic radiation emitted by the source is collimated in form of a collimated beam. Statement 6: The sensor module of any of the previous statements, wherein the electromagnetic radiation is visible light, IR, NIR, UV, or an overlap or combination thereof. Statement 7: The sensor module of statement 6, wherein the electromagnetic radiation is visible light in the wavelength range of 600 nm to 700 nm. Statement 8: The sensor module of any of the previous statements, wherein the same aperture of the collector is a primary aperture of the cavity. Statement 9: The sensor module of any of statements 5 to 8, wherein the detector is arranged around the collimated beam. Statement 10: The sensor module of any of the previous statements, wherein the detector includes a shape of a substantially annular section, for example an annulus. Statement 11: The sensor module of any of the previous statements, wherein the source and the detector have an axial arrangement. Statement 12: The sensor module of any of the previous statements, wherein the cavity comprises a secondary aperture for allowing a part of the electromagnetic radiation which was not scattered to exit without being reflected to the detector. Statement 13: The sensor module of statement 12, wherein the source, the detector, and the secondary aperture have an axial arrangement. Statement 14: The sensor module of statement 13, wherein the axial arrangement and the axis of revolution are aligned. Statement 15: The sensor module of any of the previous statements, wherein the collector comprises a second opening, the first opening and the second opening forming a passage for the aerosol, for allowing aerosol flow through the cavity. Statement 16: The sensor module of statement 15, wherein the second opening and the secondary aperture coincide. Statement 17: The sensor module of any of the previous statements, wherein the source is comprised in a cap, wherein the cap is configured to close the primary aperture of the collector, thereby closing the cavity, and wherein, optionally, the detector is comprised in the cap. Statement 18: The sensor module of statement 17, wherein the cap comprises an orifice for the placement of the LED, wherein, optionally, the orifice is a collimating hole. Statement 19: Use of a sensor module according to any of the previous statements, as a sensor module integrated in an electronic device or as a sensor module connectable to an electronic device. Statement 20: An electronic device comprising a sensor module according to any of the previous statements.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A sensor module for detecting particulate matter of an aerosol, comprising
a collector for electromagnetic radiation, the collector comprising
a cavity, wherein the cavity is reflective for the electromagnetic radiation, and
a first opening for the aerosol, for allowing exchange of the aerosol in and out of the cavity;
a source of electromagnetic radiation arranged to project the electromagnetic radiation onto the aerosol, wherein at least a part of the electromagnetic radiation may be scattered by the particulate matter in the cavity so as to become scattered electromagnetic radiation;
a detector of electromagnetic radiation arranged to detect the scattered electromagnetic radiation that is reflected by the collector;
wherein the source and the detector are arranged on a same side, preferably at a same aperture, of the collector.

2. The sensor module of claim 1, wherein the collector is a compound elliptical collector.

3. The sensor module of claim 1, wherein the collector is a compound parabolic collector.

4. The sensor module of claim 1, wherein the cavity is a surface of revolution having an axis of revolution.

5. The sensor module of claim 1, wherein the electromagnetic radiation emitted by the source is collimated in form of a collimated beam.

6. The sensor module of claim 1, wherein the electromagnetic radiation is visible light, IR, NIR, UV, or an overlap or combination thereof.

7. The sensor module of claim 6, wherein the electromagnetic radiation is visible light in the wavelength range of 600 nm to 700 nm.

8. The sensor module of claim 1, wherein the same aperture of the collector is a primary aperture of the cavity.

9. The sensor module of claim 5, wherein the detector is arranged around the collimated beam.

10. The sensor module of claim 1, wherein the detector includes a shape of a substantially annular section, for example an annulus.

11. The sensor module of claim 1, wherein the source and the detector have an axial arrangement.

12. The sensor module of claim 1, wherein the cavity comprises a secondary aperture for allowing a part of the electromagnetic radiation which was not scattered to exit without being reflected to the detector.

13. The sensor module of claim 12, wherein the source, the detector, and the secondary aperture have an axial arrangement.

14. The sensor module of claim 13, wherein the axial arrangement and the axis of revolution are aligned.

15. The sensor module of claim 1, wherein the collector comprises a second opening, the first opening and the second opening forming a passage for the aerosol, for allowing aerosol flow through the cavity.

16. The sensor module of claim 15, wherein the second opening and the secondary aperture coincide.

17. The sensor module of claim 1, wherein the source is comprised in a cap, wherein the cap is configured to close the primary aperture of the collector, thereby closing the cavity, and wherein, optionally, the detector is comprised in the cap.

18. The sensor module of claim 17, wherein the cap comprises an orifice for the placement of the LED, wherein, optionally, the orifice is a collimating hole.

19. Use of a sensor module according to claim 1 as a sensor module integrated in an electronic device or as a sensor module connectable to an electronic device.

20. An electronic device comprising a sensor module according to claim 1.
